(19) United States
(12) Patent Application Publication
(10) Pub. No.: US 2011/0036323 A1
(43) Pub. Date: Feb. 17, 2011

(54) COMBUSTION ENGINE

(76) Inventor: George Flenche, South Australia (AU)

Correspondence Address: BIO INTELLECTUAL PROPERTY SERVICES (BIO IPS) LLC, 8509 KERNON CT., LORTON, VA, 22079, US

(21) Appl. No.: 12/988,264

(22) PCT Filed: Apr. 16, 2009
(86) PCT No.: PCT/AU2009/000468

§ 371 Date: Oct. 15, 2010

(30) Foreign Application Priority Data
Apr. 16, 2008 (AU) 2008901866

(51) Int. Cl. F02F 3/00

(52) U.S. Cl. 123/193.6

(57) ABSTRACT

A combustion engine wherein said engine includes a cylinder chamber, a cylindrical piston adapted to move up and down within a defined passageway provided for by said cylinder chamber. The piston is characterised in having at one end of the piston a segment of the circumferential edge of the piston end at a raised elevation with respect to a diametrically opposed circumferential edge segment of said piston end, such that the end face of the piston is configured as an ellipse. The cylinder chamber passageway has an ellipse end configuration of comparable dimension and inclination to the ellipse piston end face, such that when the ellipse piston face is moved up the cylinder passageway during a compression stroke and at the moment of combustion ah ignited mix of air and fuel injected into the cylinder has a contactable surface area of the ellipse face of the piston to power a return of the piston to its lower position inside the cylinder chamber passageway after the combustion event.

### TECHNOLOGICAL FIELD

This invention relates to an internal combustion engine and more particularly to an improvement in the cylinder and contained piston to provide greater performance of the engine.

### BACKGROUND ART

From the outset the draftsperson wishes to advise that it is the inventors purpose to provide an improved combustion engine of which such improvement could be provided for regardless of the number of cylinders contained within the engine.

As will be noted from the following for the most part the engine described has just the single cylinder whereas in the preferred embodiment where greater detail is provided for there is presented a four cylinder engine the type most people skilled in the art would associate with an automobile engine.

Nonetheless the focus of this invention is in fact connected with the cylinder and related piston hence the improvement is provided for whether or not the engine contains 1, 4, 6, 8 and so forth cylinders.

It is also important to note at this introductory stage the improved combustion engine has the cylinder and piston adapted to be suitably arranged as they currently are in any multi-cylinder engine arrangement including inline, V or flat also often referred to as horizontally opposed or boxer.

For the most part the person skilled in the art is well familiar as to how conventional internal combustion engines work.

Still further the preferred embodiment shows both Scotch Yoke as well as more conventional engine arrangements, as the cylinder improvement of this invention is applicable to all such engine arrangements.

Nonetheless a brief discussion of the general cycle of converting fuel into motion to provide engine performance does provide the opportunity to highlight how the conventional combustion cycle to produce this motion using traditional cylinders and pistons is not providing optimum performance.

One of the main problems with internal combustion engines is that as the compression stage completes and that moment of time when the spark is provided and ignition of the fuel takes place, it will ultimately be the expansion of the ignited air and fuel that will drive the piston to provide engine performance.

The ability of the ignited air which is undergoing expansion to drive the piston will be dependent on the surface area available at the piston end face which comes in contact with the expanding ignited air during the combustion cycle immediately following the compression stroke of the piston being driven up within the cylinder.

As is to be expected the greater surface area available for that contact between the air fuel ignited mixture and the face of the piston the greater the performance.

This is supported by Pascal's Law wherein equal force of gases on all surface, area and also Newton's Law wherein every action has an equal and opposite reaction.

Therefore if it was possible to increase the surface area of the piston head as contact is made between the ignited air and fuel mixture with the piston head greater opportunity is provided for to drive the piston downwards during the combustion cycle to improve overall performance of the engine.

Nonetheless if one is to simply increase the surface area of the end face of the piston to provide a greater diametrically exposed surface of interaction between the piston end and the ignited air fuel mixture, the engine and the components themselves would have to be increased in size which for the most part would counteract any perceived improvement.

Still further for the most part the application of internal combustion engines require the engine itself to be of design and size conducive to fit under the bonnet of a motor vehicle or even in the case of single cylinder arrangements within the basic confines of a lawn mower or the like.

Therefore there is not the luxury of being able to alter the dimensions of the diameters of the cylinder and pistons contained with the engine to provide that increased surface area for that contact stage between the air fuel mixture and the face of the piston during combustion.

Therefore there remains a need in this general technology of combustion engines to be able to utilise the traditional or conventional bore sizes of the cylinder and the enclosed piston which is movable up and down inside the cylinder during the intake, compression, combustion and exhaust strokes of the combustion cycle.

Accordingly an object of this invention is to provide an improved combustion engine that can provide greater engine performance than conventional or traditional engines utilising standard piston and cylindrical bore sizes.

A further object of this invention is to ameliorate or at least substantially reduce the problems referred to above and proyide members of the purchasing public with an Improved combustion engine that would otherwise have not been available if additional performance is required.

Further objects and advantages of the invention will become apparent from a complete reading of this description.

### SUMMARY OF THE INVENTION

Accordingly in one form of the invention there is provided a combustion engine, said engine including;

a cylinder,

a cylindrical piston adapted to move up and down within a defined passageway provided for by said cylinder,

said piston characterised in having a segment of said pistons circumferal edge at one face end of said piston being of raised elevation with respect to a diametrically opposed segment of said segment of the circumferal edge of said piston such that the end face of the cylindrical piston is configured as an ellipse,

said cylinder including a matching ellipse end configuration with said ellipse piston end face when said piston is extended in an upward position,

such that when the ellipse piston face is moved up the cylinder during a compression stroke and at the moment of combustion an ignited mix of air and fuel is provided with a contactable surface area of the ellipse face of the piston so as to return the piston to its lower position inside the cylinder after the combustion event.

In preference the elevation discrepancy between the respective diametrically opposed segments along the circumferal edge of the piston end face provides for an angle of 45°.

An advantage of such an arrangement is that for the first time greater performance is provided within each cylinder to provide enhanced power during the combustion stroke as the piston is forced downward by the ignited mixture of air and fuel.

Advantageously this improved power stroke is provided for because a greater surface area has been provided for within the cylinder for the contact between the piston head or face with the ignited air and fuel mixture.

This expansion of the surface area which will allow contact between the piston face end and the air fuel mixture has been provided for without increasing the bore size of the cylinder and/or standard cylinder head cc.

Advantageously the differential elevation between diametrically opposed portions along the circumferal edge of the end surface of the piston means that there is an inclined or tapered surface providing a larger surface area for the respective contact with the ignited air fuel mixture.

This simple incline or tapering of the conventional bore of the piston preferably at 45° makes the most efficient angle to take the effect of converting the expanded gases into power stroke and surface area.

Advantageously the conventional piston which for the most part is a cylindrical piece of metal that moves up and down inside the cylinder can maintain its design and usability. The only difference being as introduced above is this unique tapering or inclined effect at the end of the piston which advantageously provides that additional surface area which then allows greater contact with the expanding gases of the combined air and fuel which subsequently provides for an improved power stroke during the combustion stroke.

While the piston end face has a slight alteration with the tapering or inclined feature being a part of that design, the standard piston rings that provide a sliding seal between the outer edge of the piston and the inner edge of the cylinder can all still remain as part of the arrangement for this invention.

Hence while the design provides a significant different feature in construction of the end face of the piston such an alteration advantageously has no effect on the overall design of the combustion engine other than providing for performance increases to levels even as much as 41%.

Advantageously standard designs in compression rings, crank shafts, connecting rods, the main engine block and the like can all still remain the same with the-application of this unique feature of the invention by having the piston end face featuring a unique angling or tapering effect at its distal end.

In preference the ellipse end face of the piston includes a series of ridges and troughs, also describable as rippling across its surface so as to provide a further increase in the usable area of the piston end face for greater surface area engagement between the piston end face and the expanded gases contained in the air fuel mixture.

Advantageously the flat surface area of the tapered piston will not allow a swirling effect and in fact for the most part will allow an even flame front, of which those skilled in the art appreciate is the most efficient form of combustion.

Advantageously as the ellipse configuration of the piston end face provides a greater surface area, this also advantageously defines a greater usable area to which further valve heads can be introduced into the design.

As the person skilled in the art will appreciate the intake and exhaust valves are responsible for opening at the proper time to let air and fuel in to the cylinder and at the same time let out exhaust during that part of the combustion cycle.

While all valves are closed during the compression and combustion stage of the combustion cycle to keep the chamber sealed, as is to be appreciated during the stages of intake in exhaust it would be advantageous to get as much air and fuel in as well as exhaust as much combusted air out during the remaining stages.

The more valves designable to work with the piston is always preferred, or alternatively larger valves.

Nonetheless as is to be expected from the conventional standard piston as the piston is simply a cylindrical piece of metal with a flat face again the usable area over the standard cylinder head is limited.

Advantageously with this invention by introducing the incline or the tapered effect that the surface end of the piston head and the corresponding standard cylinder head the ellipse configuration provides for a greater surface area of such a shaping which means that it is then possible to introduce additional valves into the arrangement.

This larger ellipse surface area cannot only be used for additional valves but also larger valves which as the person skilled in the art will appreciate increases efficiency of gases entering and existing the cylinders.

In order to describe the invention in greater detail and also to list some further advantageous features that are complementary to the main scope of this invention the preferred embodiment will be described hereafter presenting a four-cylinder combustion engine.

Nonetheless as introduced above this engine is applicable to a variety of applications and not only those kinds of engines that one would expect to form parts of automobiles. The improved combustion cycle provided for in the unique cylinder and piston arrangement works just as well in one-cylinder engines as well as those with multi-cylinder engines.

Again as introduced above the final arrangement of the engine block and the positioning of the cylinders and their arrangement whether it be inline, V or flat is incidental to the essential feature of this invention as the improved aspects of this invention by virtue of the incline or tapered effect of the piston end face works in any such arrangement.

### BRIEF DESCRIPTION OF THE DRAWINGS

FIG. 1 shows a perspective view of a preferred combustion engine of this invention using a Scotch Yoke engine arrangement with four-cylinders and a six valve head for each cylinder.

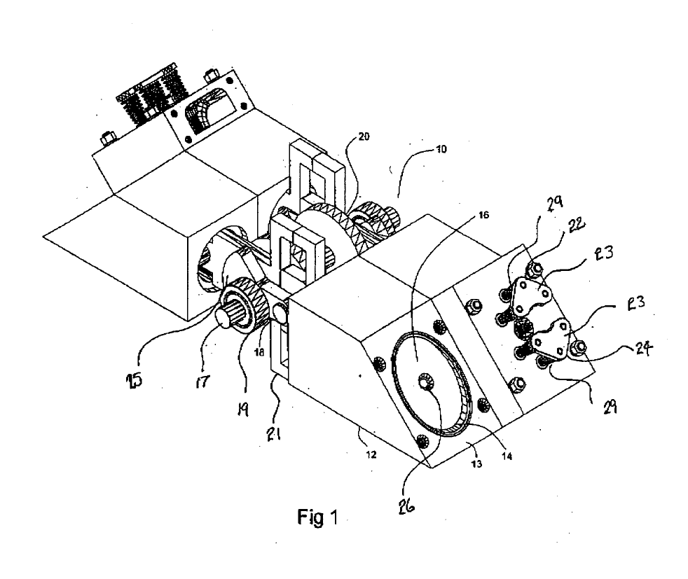

FIG. 2 is a top view of FIG. 1.

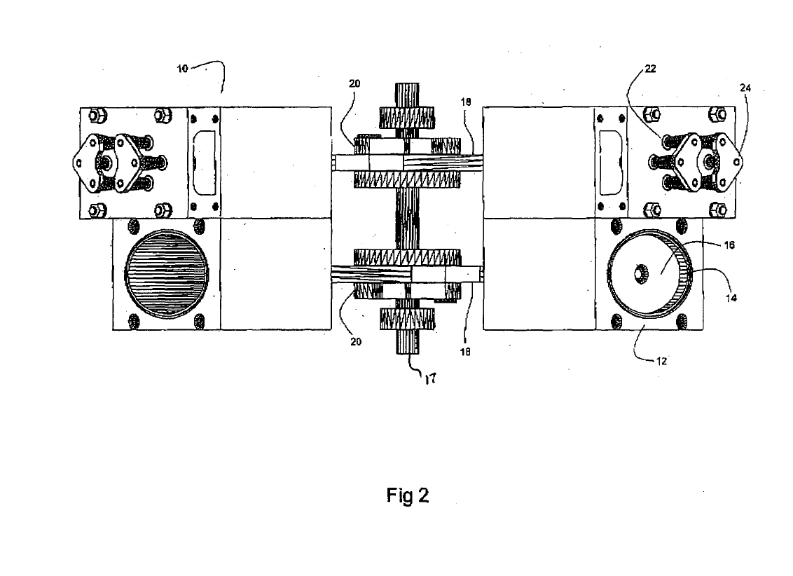

FIGS. 3a and 3b show perspective and cross-sectional views of the piston to which is moved up and down the, or each cylinder of the combustion engine.

FIGS. 4a, 4b and 4c show a top view looking down at the ellipsed piston end face with a series of ridges and troughs included on the end face to increase the usable surface contact area, wherein the rippling is presented in a different configuration for each of FIGS. 4a; 4b and 4c.

FIGS. 5a and 5b show a perspective and a cross-sectional side view of the cylinder for the engine having a matching ellipse end.

FIG. 6 shows a further embodiment of the invention wherein the ellipse form end face of the piston provides greater usable area for larger or further valves to be introduced into the design.

FIG. 7 introduced as a further embodiment of the invention associated with the sparking mechanism to ignite the air and fuel mixture.

FIGS. 8a and 8b shows the cylinder and piston arrangement with a more conventional combustion engine arrangement.

### DETAILED DESCRIPTION OF THE DRAWINGS

Referring to the drawings in greater detail where there is provided a four cylinder combustion engine shown generally as 10 the engine includes cylinder 12 having tapered or inclined ends 13.

The cylinder 12 defines a passageway 14 to which the piston 15 can be moved up and down during the various intake, compression, combustion and exhaust strokes during operation.

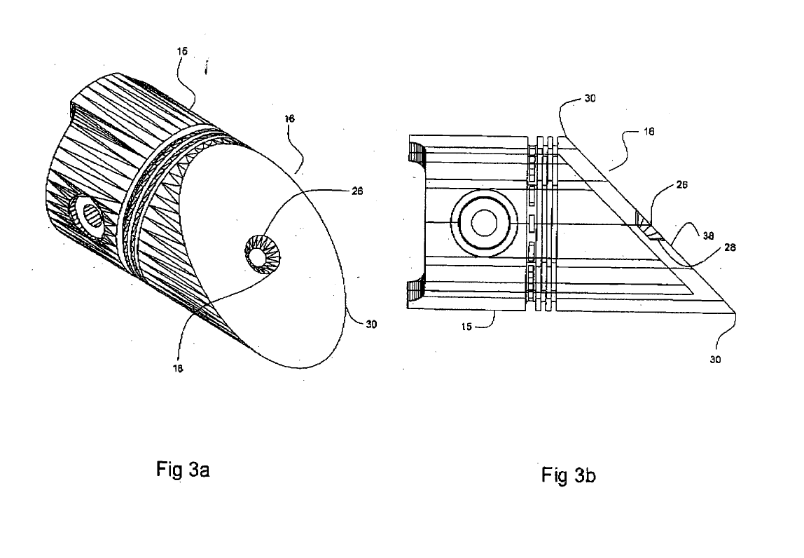

As best seen in FIGS. 3a and 3b the end face or surface 16 of the piston 15 is inclined or tapered and provides for the ellipse configuration.

As introduced above numerous times preceedingly this ellipse form provides for greater surface contact area for engagement with the ignited air and fuel mixture as well as providing greater usable area for the addition of further intake, and exhaust valves shown as numbers 22 and 24 respectively.

Though not central to the invention the piston is connected to a crank shaft mechanism shown generally as 20 via a connecting rod 18. There is also crankshaft extension 25, crankshaft input/out put 17 and bearings 19.

The cylinder 12 ends 13 are tapered at the same angle as the piston face end 16. As the person skilled in the art will appreciate the cylinder heads are flat-faced and connected to the cylinder block as per usual with conventional engines.

Cylinder 12 volume, compression ratio, bore/stroke are all for the most part identical to conventional engines with the only difference being the surface area change referred to above through the introduced feature of inclining or tapering the piston end face.

As the person skilled in the art will appreciate from the figures there is the same design of piston, cylinder and heads for both petrol or diesel arrangement with only the compression changes noted.

The piston 15 tapered ends 16 have a flat face with the bore/stroke all identical to conventional engines with only the surface area changes referred to above altering the conventional design.

As the person skilled in the art will appreciate the design of the piston will be the same for either petrol or diesel with only compression changes required.

The tapered or incline feature of the end surface of the piston has no effect on piston wear and cooling is the same as conventional pistons.

The arrangement provided for in the figures as throughout the description provide equal pressure on the piston face and the cylinder head with the flame path always constant.

Dimple 26 with its tapered or inclined insert 28 allows for controlled initial commencement of the flame burning.

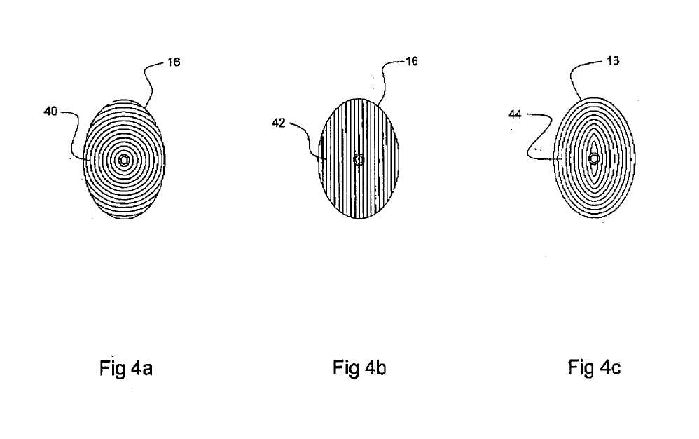

FIGS. 43, 4b and 4c show a variety of ways in which the ripple effect can be introduced onto the surface of the piston end wherein FIG. 4a shows a circular pattern 40, FIG. 4b vertical 42 and FIG. 40 an ellipse or oval configuration 44.

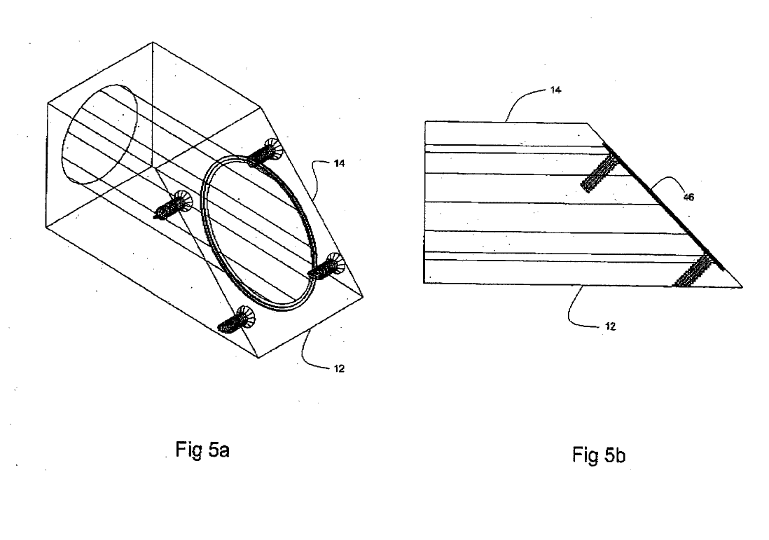

FIG. 5a shows a more detailed view of the tapered cylinder 14 which as can be noted is tapered only at one end. As introduced preceedingly bore/stroke are identical to conventional engines and there is the same design of the cylinder for petrol or diesel engines.

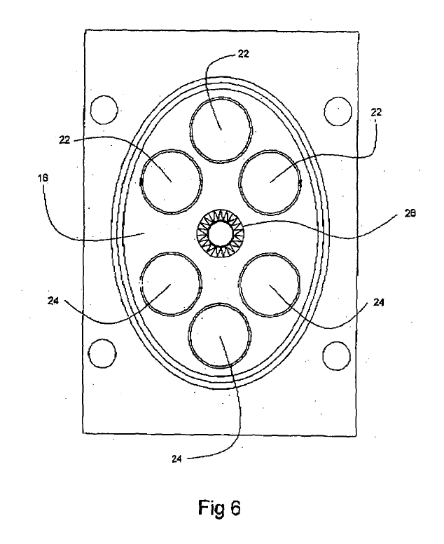

FIG. 6a shows a schematic arrangement of the intake and exhaust valves wherein by virtue of the ellipse configuration provides a greater usable surface area for the valves 22 and 24 to be introduced. The valve spring assemblies 29 and the valve top plates 23 provide for six valve arrangement per cylinder 12.

While in this particular embodiment additional valves are introduced there is the opportunity with the greater surface area available to also introduce larger valves rather than necessary additional valves.

The cross flow design allows inlets air/fuel on one side and exhaust outlet on the other with a large smooth design for better breathing and exhausting. Multiple fuel injections are also available and while the embodiment shows just the single spark plug for ignition the arrangement is certainly not a limited one due to the unique ellipse shape.

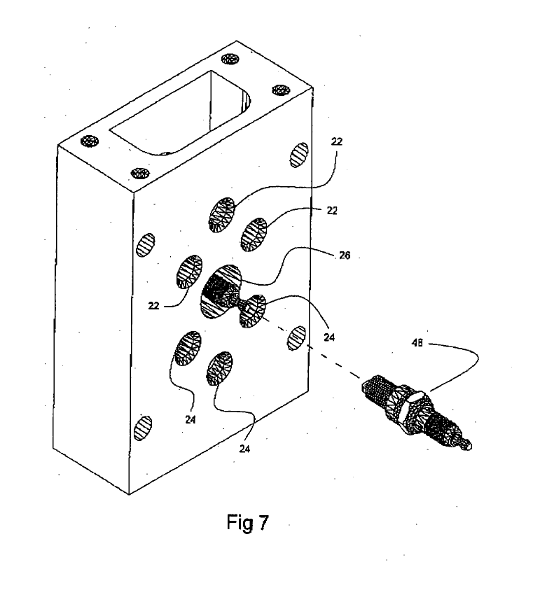

FIG. 7 shows an exploded view of the spark plug 48 being introduced into the arrangement where the piston head with the spark plug is in the centre of the head. There is enough space to allow direct fuel injection or multiple fuel injectors which can also allow multiple timed injections.

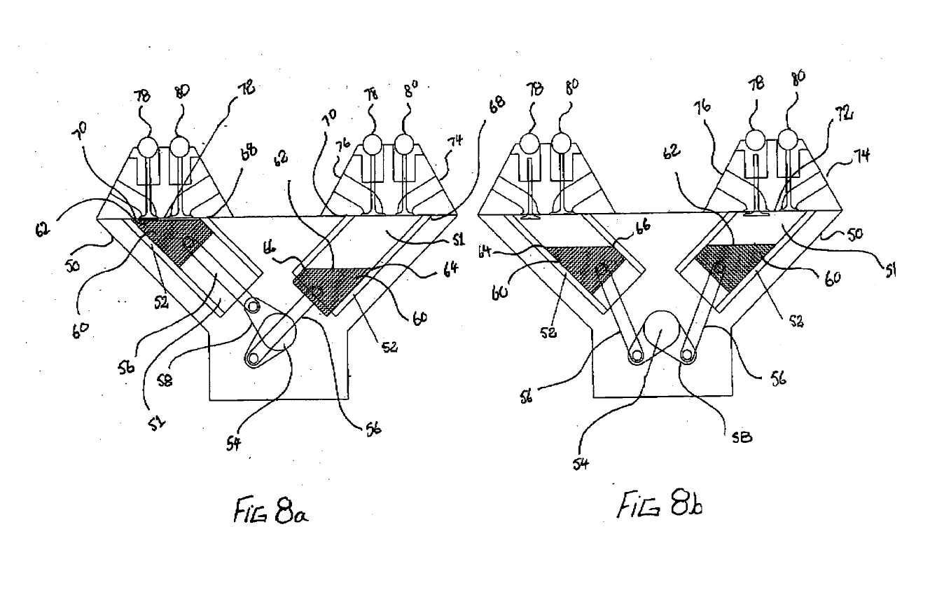

In FIGS. 8a and 8b, cylinder chambers 52 are housed in a conventional engine block 50. The cylinder chambers 52 provide the passageways 51 to which the respective pistons 60 are guided therein for the four stroke operation of the combustion engine. The piston 60 is connected to rod 56 and plate 58 to be connected to the crank shaft 54.

The piston 60 has an end face 62, of which upper circumferential edge 64 and lower circumferential edge 86, provide an ellipse piston face end 62. When looked at in cross section the piston 60 has an appearance that the piston end is inclined of tapered. In the embodiment shown in FIGS. 8a and 8b, the incline is 45 degrees.

The cylinder chamber 52 also at one end provides a complimentary ellipse configuration to the piston 60 (as best seen in the left hand side cylinder chamber 52 of engine black 50 in FIG. 8a), provided for by edges 68 and 70 of the cylinder chamber 52.

The cylinder chamber 52 is sealed off conventionally as shown at 72, and intake and exhaust chambers and values 74, 76,78 and 80 to control the air and exhausting of burnt fuel all are configured and act conventionally as they would in a conventional combustion engine.

As the person skilled in the art will appreciate all current advanced technologies in engine efficiencies, for example direct fuel injection, turbo, turbo compounding, variable valve timing and the like can all be used to their full effect in the arrangements provided for in this invention.

1. A combustion engine, said engine including;
a cylinder chamber,
a cylindrical piston adapted to move up and down within a defined passageway provided for by said cylinder chamber,
said piston characterised in having at one end of the piston a segment of the circumferential edge of the piston end at a raised elevation with respect to a diametrically opposed circumferential edge segment of said piston end, such that the end face of the piston is configured as an ellipse,
said cylinder chamber passageway having a ellipse end Configuration of comparable dimension and inclination to the ellipse piston end face,
such that when the ellipse piston face is moved up the cylinder passageway during a compression stroke and at the moment of combustion an ignited mix of air and fuel injected into the cylinder has a contactable surface area of the ellipse face of the piston to power a return of the piston to its lower position inside the cylinder chamber passageway after the combustion event.

2. The engine of claim 1 wherein the raised elevation between the respective diametrically opposed segments along the circumferential edge of the piston end face provides for a piston end with a cross sectional angle of 45°.

3. The engine of claim 1 or 2 wherein the ellipse end face of the piston includes a series of ridges and troughs across the piston end face so as to provide a greater surface area contact of the combusting air fuel mixture with the piston end face.

4. The engine of anyone of the proceeding claims wherein each piston end face includes a dimple with a tapered insert for controlled initial commencement of the flame burning.

5. The engine of claim 3 wherein the series of ridges and troughs across the piston end face are arranged in a circular pattern.

6. The engine of claim 3 wherein the series of ridges and troughs across the piston end face are arranged in a vertical or horizontal pattern.

7. The engine of claim 3 wherein the series of ridges and troughs across the piston end face are arranged in an ellipse or oval pattern.
